(19) United States
(12) Patent Application Publication
(10) Pub. No.: US 2026/0271837 A1
(43) Pub. Date: Sep. 17, 2026

(54) Planter Device

(71) Applicant: Vina Planters, LLC, Boynton Beach, FL (US)

(72) Inventors: Sarah Joy Figueredo, Boynton Beach, FL (US); Miguel Angel Figueredo, Boynton Beach, FL (US)

(21) Appl. No.: 19/080,794

(22) Filed: Mar. 15, 2025

(51) Int. Cl. A01G 9/02

(52) U.S. Cl. CPC A01G 9/0302

(57) ABSTRACT

The present disclosure provides a planter device with four sides, a bottom portion, and one or more structural apertures. In some embodiments, the four sides and the bottom portion may include at least one attachment mechanism and at least one securing mechanism. In some aspects, the planter device may include a receiving cavity configured to receive planting material. In some implementations, the bottom portion of the planter device may include one or more feet configured to elevate the planter device.

### BACKGROUND

Traditionally, planters are made from natural materials like wood, clay, and metal. These materials continue to dominate the gardening industry despite certain deficiencies that they hold. Natural materials like wood and metal may weather over time and become unusable. For example, wood may rot or be susceptible to pests like termites and metal may be susceptible to rust. Clay or other ceramic planters are often fragile and may break under stress.

In addition, these traditional planters are heavy and expensive. Metal, clay, and wood are heavy materials that are difficult to move around, especially when filled with soil and plants. Together, these issues continue to make gardening an expensive and arduous process, wherein it takes a lot of time, physical effort, and finances to sustain a healthy plant and flower environment. There is a need for an alternative planter that avoids the deficiencies of natural materials without creating new problems.

Plastic planters offer a potential solution as they are lightweight, cheap, and have longevity. These types of planters have very low maintenance, high durability, and may even reduce the amount of watering required with plants as they are a less porous material. Still, these plastic planters have disadvantages that have prevented them from replacing natural materials. Plastic planters are often non-biodegradable and have issues with root health and overwatering. More specifically, plastic planters have poor aeration and water evaporation which may harm the plants and flowers.

If there was a planter that avoided the deficiencies of natural materials without introducing the current disadvantages of plastic planters, it may provide a strong option for gardening and planting. As it stands, the limitations of plastic planters may be addressed through modifying their current utility and functionality to avoid overwatering and the degradation of root health. This planter may be long-lasting, cost-effective, and lightweight without harming the livelihood of the plants and flowers.

### SUMMARY OF THE DISCLOSURE

What is needed is a planter device configured to receive planting material. In some embodiments, the planter device may include four sides, wherein each of the four sides may include at least one upper edge that may define the opening of a receiving cavity and at least one lower edge configured to interact with a bottom portion. In some implementations, the bottom portion may be perpendicular to the four sides, wherein the bottom portion may be detachably connected to each of the four sides and each of the four sides and the bottom portion substantially form a rigid cuboidal structure that may surround the receiving cavity configured to receive a planting material.

In some aspects, the four sides may include one or more structural apertures centrally positioned on each of the four sides that provide openings into the receiving cavity. In some implementations, the four sides may include at least one attachment mechanism positioned on the edges of each of the four sides except the at least one upper edge, wherein the at least one attachment mechanism may be configured to attach to each of the four sides and the bottom portion of the planter device.

In some embodiments, the bottom portion may include one or more slots positioned to provide openings into the receiving cavity. In some aspects, the bottom portion may include at least one attachment mechanism positioned on the edges of the bottom portion, wherein the at least one attachment mechanism may be configured to connect to the at least one attachment mechanism of the four sides. In some implementations, at least one securing mechanism may be configured to secure the four sides and the bottom portion of the planter device together.

A number of embodiments of the present disclosure will be described. While this specification contains many specific implementation details, these should not be construed as limitations on the scope of any disclosures or of what may be claimed, but rather as descriptions of features specific to particular embodiments of the present disclosure. It is understood to those skilled in the art that variations, modifications, and alterations may be apparent. It will be understood that various modifications may be made without departing from the spirit and scope of the disclosure.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1 illustrates a planter device, according to some embodiments of the present disclosure.

FIG. 2 illustrates an exploded view of a planter device, according to some embodiments of the present disclosure.

FIG. 3 illustrates a perspective view of a planter device, according to some embodiments of the present disclosure.

FIG. 4 illustrates a top view of a planter device, according to some embodiments of the present disclosure.

FIG. 5 illustrates a bottom view of a planter device, according to some embodiments of the present disclosure.

FIG. 6 illustrates a plurality of planter devices, according to some embodiments of the present disclosure.

FIG. 7 illustrates an exploded view of a planter device, according to some embodiments of the present disclosure.

FIG. 8 illustrates a perspective view of a planter device, according to some embodiments of the present disclosure.

FIG. 9 illustrates a plurality of planter devices, according to some embodiments of the present disclosure.

The Figures are not necessarily drawn to scale, as their dimensions can be varied considerably without departing from the scope of the present disclosure.

### DETAILED DESCRIPTION

The present disclosure provides generally for a planter device. According to the present disclosure, the planter device may include four sides and a bottom portion. In some implementations, the planter device may include one or more structural apertures. In some aspects, the planter device may include a receiving cavity configured to contain planting material.

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Planter Device: as used herein refers to a device configured to receive the planting material. In some aspects, the planter device may be rectangularly shaped, wherein the planter device includes a top portion and a bottom portion parallel to the top portion. In some aspects, the top portion may comprise a planting aperture, wherein the top portion may not include any structural material and instead provide access to an internal cavity within the planter device. In some embodiments, the bottom portion and the four sides of the planter device may include structural apertures. In some implementations, the bottom portion, and the four sides of the planter device may be separate components that may be attachable via an attachment mechanism.
Planting material: as used herein refers to the materials that may be configured to enter the internal cavity of the planter device, wherein the planter device may be configured to contain the planting material. By way of example and not limitation, the planting material may include soil, plants, flowers, vegetative matter, and other materials necessary for plant growth and development. In some aspects, the planting material may be that of an orchard, as non-limiting example.
Feet: as used herein refers to one or more protruding structure located on the bottom portion of the planter device. In some embodiments, the feet of the planter device may elevate the planter device above an underlying surface, wherein the feet may provide stability, facilitate airflow, and regulate water drainage, as non-limiting examples. In some aspects, the feet may be circular, rectangular, or other geometric shapes, as non-limiting examples. In some implementations, the feet may be integral to the planter device or it may attach as a separate piece or pieces to the planter device, as non-limiting examples.
Attachment mechanism: as used herein refers to one or more portions of the planter device configured to attach the bottom portion and the four sides of the planter device together to form the planter device. In some implementations, the attachment mechanism may include an interlocking mechanism. In some aspects, the bottom portion and the four sides may include the attachment mechanism, wherein they may include a protruding section and a recessed section, wherein the protruding section of one component may be configured to attach to the recessed section of another component. In some aspects, each component may include several protruding sections and recessed sections, wherein the several protruding sections and the several recessed sections of one component may be attached to the several recessed sections and the several recessed sections of another component.

Securing mechanism: as used herein refers to one or more components of the planter device configured to secure the components together. In some aspects, the securing mechanism may include one or more screws, a snap and lock mechanism, or glue, as non-limiting examples.
Structural apertures: as used herein refers to the holes on the bottom portion and the four sides of the planter device. In some aspects, the planter device may include a one or more structural apertures, wherein the one or more structural apertures may be a variety of shapes and designs, as non-limiting examples.

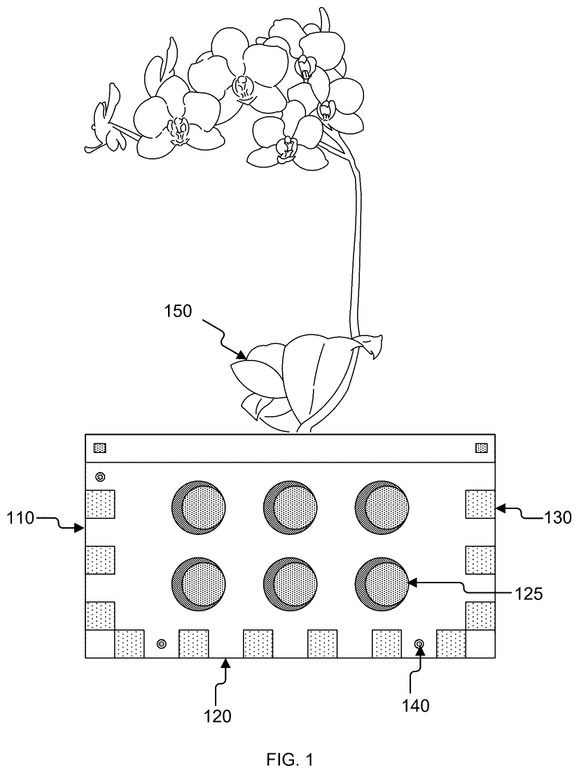

Referring now to FIG. 1, a planter device, according to some embodiments of the present disclosure, is illustrated. In some embodiments, a planter device may include four sides 110 and a bottom portion 120 perpendicular to the four sides 110. In some implementations, the four sides 110 and the bottom portion 120 may form a rigid cuboidal structure that may surround a receiving cavity configured to receive planting material 150. In some aspects, the four sides 110 and the bottom portion 120 may include one or more structural apertures 125 centrally positioned on the four sides 110.

In some embodiments, the four sides 110 may include at least one upper edge 112 and at least one lower edge 114. In some aspects, the at least one upper edge 112 may define the opening of the receiving cavity. In some implementations, the at least one lower edge 114 may be configured to interface with the bottom portion 120. In some aspects, the inner surface of the four sides 110 may be configured to contact the planting material 150, whereas the outer surface of the four sides may be configured to prove the external appearance of the planter device.

By way of example and not limitation, the one or more structural apertures 125 may be standard geometric shapes or stylistic designs. In some embodiments, the planter device may include at least one attachment mechanism 130 positioned on the edges of the four sides 110 except the at least one upper edge 112, wherein the at least one attachment mechanism 130 may be configured to attach the four sides 110 and the bottom portion 120 to one another. In some implementations, the planter device may include at least one securing mechanism 140 configured to secure the four sides 110 and bottom portion 120 of the planter device together. In some aspects, the planter device may include one or more feet attached to the bottom portion configured to elevate the planter device and provide stability.

In some embodiments, the planter device may include a rigid material. In some implementations, bottom portion 120 may include one or more slots centrally positioned on the bottom portion 120 that provide openings into the receiving cavity. In some implementations, the bottom portion 120 may include at least one attachment mechanism 130 positioned on its edges configured to connect to the at least one attachment mechanism 130 of the four sides. In some aspects, the bottom portion 120 and the four sides 110 may be separate components that may attach to one another to form the planter device via the at least one attachment mechanism 130. In some aspects, the at least one attachment mechanism 130 may include an interlocking mechanism. By way of example and not limitation, the interlocking mechanism may include tongue and groove.

In some embodiments, the planter device may be configured to contain planting material 150, wherein the planting material 150 may be received by the receiving cavity. In some aspects, the planting material 150 may include an orchard and soil. In some aspects, the one or more structural apertures 125 may provide breathability and moisture control to the planting material 150, as non-limiting examples. By way of example and not limitation, the securing mechanism 140 may include one or more screws, a snap and lock mechanism, or glue. In some aspects, the at least one attachment mechanism 130 may connect the four sides 110 to the bottom portion 120, wherein the securing mechanism 140 may be used to fasten the four sides 110 to the bottom portion 120, keeping it securely in place.

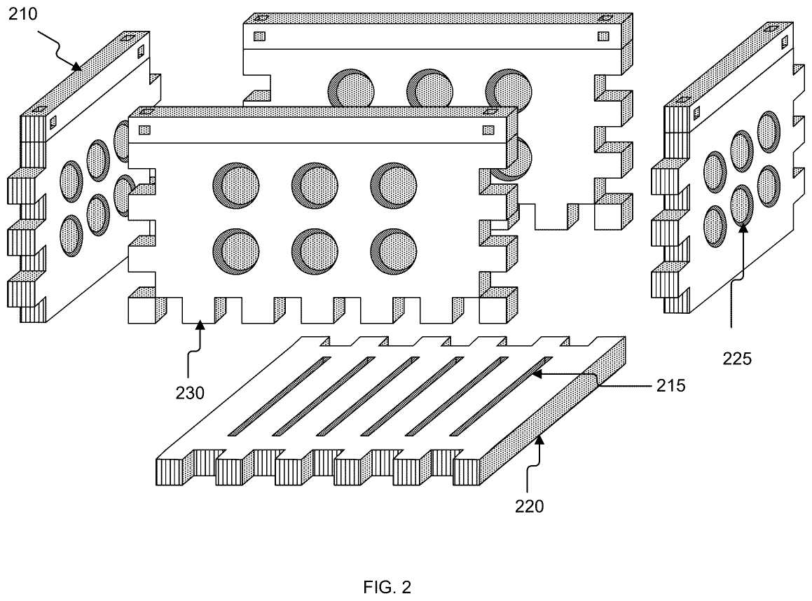

Referring now to FIG. 2, an exploded view of a planter device, according to some embodiments of the present disclosure, is illustrated. In some embodiments, planter device may include four sides 210 and a bottom portion 220. In some aspects, the four sides 210 may include structural apertures 225. In some implementations, the bottom portion 220 may include one or more slots 215. In some implementations, the four sides 210 and the bottom portion 220 may include one or more attachment mechanisms 230, wherein the at least one attachment mechanism 230 may be configured to connect the four sides 210 and the bottom portion 220.

By way of example and not limitation, the at least one attachment mechanism 230 on the side of the four sides 210 may be configured to connect with the at least one attachment mechanism 230 on the side of another of the four sides 210. By way of example and not limitation, the at least one attachment mechanism 230 on the bottom edges of the four sides 210 may be configured to connect to the at least one attachment mechanism 230 of the bottom portion 220. In some implementations, the connection of the four sides 210 and the bottom portion 220 may form a cuboidal shape with a receiving cavity, wherein the receiving cavity may be accessible from the top of the planter device.

In some embodiments, the at least one attachment mechanism 230 may include interlocking mechanisms, wherein each interlocking mechanism includes a protruding element and a recess element. By way of example and not limitation, the protruding element of one of the four sides 210 may be received by the recess element of another of the four sides 210, wherein a single side of the four sides 210 may include multiple protruding elements and recess elements to connect to a separate single side of the four sides 210 that also includes multiple protruding elements and recess elements. In some implementations, the one or more interlocking mechanisms may be configured such that when one or more of the four sides 210 may be connected, the protruding elements of one side may slide into the recess elements of an adjacent side to form a seamless joint, as a non-limiting example.

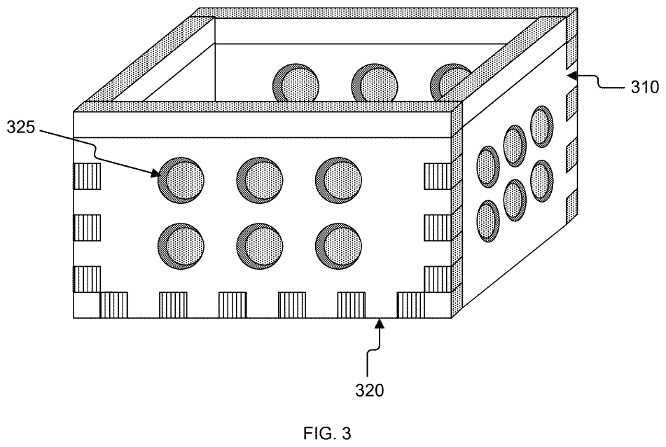

Referring now to FIG. 3, a perspective view of a planter device, according to some embodiments of the present disclosure. In some embodiments, the planter device may include four sides 310, a bottom portion 320, one or more structural apertures 325. In some aspects, the one or more structural apertures 325 may be located on the four sides 310, wherein the one or more structural apertures 325 may include holes or graphical designs distributed along the four sides 310 of the planter device.

In some implementations, the one or more structural apertures 325 may include a variety of shapes, sizes, designs, and arrangements, as non-limiting examples. In some embodiments, the one or more structural apertures 325 may be configured to facilitate water drainage, aeration, and root growth, as non-limiting examples. In some embodiments, the one or more structural apertures 325 may be reinforced with ridges or borders that may maintain the structural integrity of the planter device. In some implementations, the bottom portion 320 may include one or more slots. By way of example and not limitation, the one or more slots may be configured as holes or slits at the bottom of the receiving cavity, as non-limiting examples.

By way of example and not limitation, the one or more structural apertures 325 may be configured in an ornamental design or configuration. In some aspects, the ornamental design or configuration may include a floral theme, wherein the one or more structural apertures 325 may form flower designs, as a non-limiting example. By way of example and not limitation, the one or more structural apertures 325 may form ornamental designs like leaves, flowers, festive displays, seasonal graphics, decorative graphics, and animals, as non-limiting example.

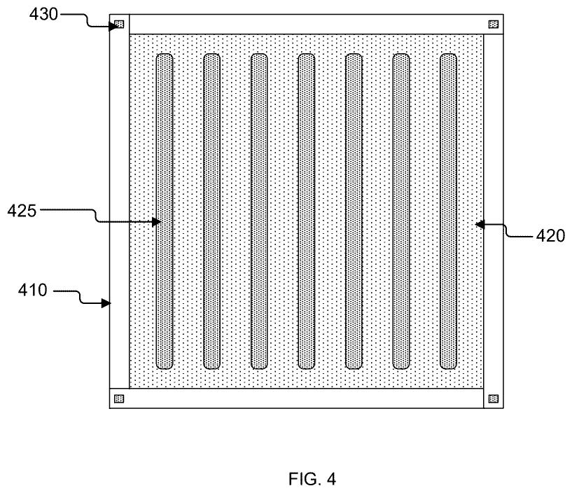

Referring now to FIG. 4, a top view of a planter device, according to some embodiments of the present disclosure. In some embodiments, the planter device may include four sides 410 and a bottom portion 420. In some implementations, the four sides 410 and the bottom portion 420 may be configured to create a rigid container with a receiving cavity configured to hold planting material. In some aspects, the four sides 410 may include one or more structural apertures and the bottom portion may include one or more slots 425.

In some embodiments, the four sides 410 and the bottom portion 420 may include one or more securing mechanisms 430 configured to reinforce and bind the components to one another. By way of example and not limitation, the one or more securing mechanisms 430 may include screws, pins, clips, or brackets. In some implementations, the one or more securing mechanisms 430 may be placed to ensure that the planter device remains stable under various conditions like weather exposure, heavy weight, physical contact, and pests, as non-limiting examples.

In some aspects, the one or more securing mechanisms 430 may be attachable and removable from the planter device. In some implementations, the one or more securing mechanisms 430 may be attached to maintain the structural integrity of the planter device, as a non-limiting example. In some aspects, the one or more securing mechanisms 430 may be removed to take apart the planter device, wherein the planter device may be configured to be easily broken down for easy storage and transport.

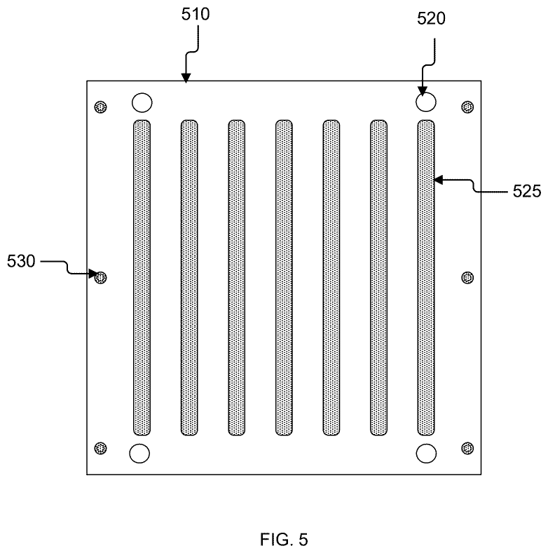

Referring now to FIG. 5, a bottom view of a planter device, according to some embodiments of the present disclosure, is illustrated. In some embodiments, the bottom portion 510 of the planter device may include one or more slots 525 and one or more securing mechanisms 530. In some implementations, the one or more slots 525 may include holes or slits across the bottom portion 510. In some aspects, the one or more securing mechanisms 530 may include screws, pins, clips, or brackets, as non-limiting examples.

In some embodiments, the bottom portion of the planter device may include an internal facing side and an external facing side. In some aspects, the internal facing side may be configured to receive the planting material, wherein the internal facing side faces a receiving cavity of the planter device. In some implementations, the external facing side may include one or more feet 520 configured to elevate the planter device above the ground or any supporting surface.

By way of example and not limitation, the one or more feet 520 may include anti-slip features like rubber pads or a textured surface. In some implementations, the one or more feet 520 may create a gap between the external facing side and the ground or any supporting surface, wherein the one or more feet 520 may promote airflow and water circulation. In some aspects, the one or more feet 520 may provide support against physical stress, pests, or environmental factors.

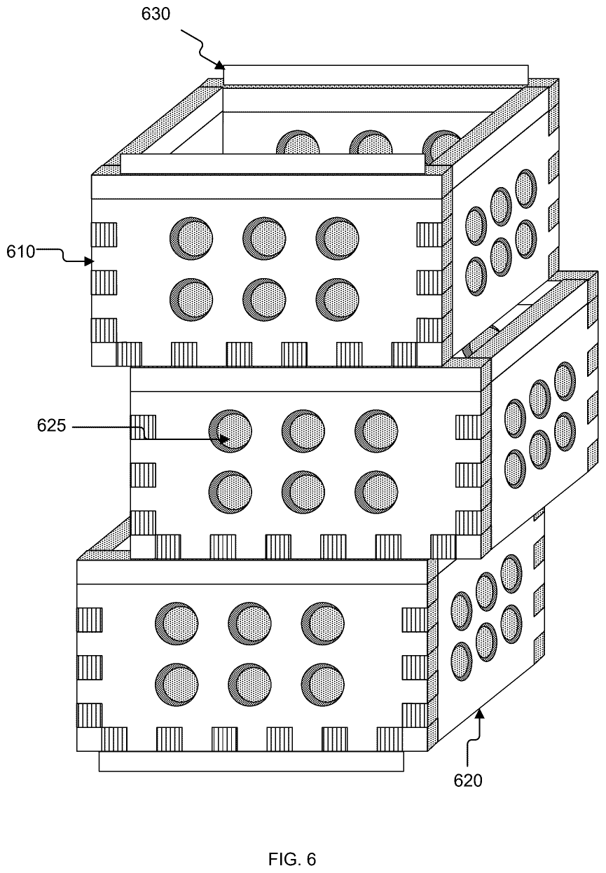

Referring now to FIG. 6, a plurality of planter devices, according to some embodiments of the present disclosure, is illustrated. In some embodiments, the plurality of planter devices may include multiple planter devices. In some implementations, each of the plurality of planter devices may include four sides 610, a bottom portion 620, and one or more structural apertures 625. In some aspects, each planter device may be configured to contain planting material, wherein the plurality of planter devices may be configured to hold a plurality of planting material. In some implementations, the bottom portion 620 may include one or more slots.

In some embodiments, the four sides 610 may include a top surface and a bottom surface, wherein the top surface and bottom surface of the four sides 610 may include a connection mechanism 630. In some implementations, the connection mechanism 630 of the four sides 610 may be configured to connect to the connection mechanism 630 of another planter device, wherein the plurality of planter devices may be connectable. By way of example and not limitation, the connection mechanism 630 may include a snap and lock feature or a sliding lock, wherein the connection mechanism 630 of one planter device may snap into place against the connection mechanism 630 with another planter device.

In some embodiments, the plurality of planter devices may be stacked onto one another, wherein planting material may be contained within each of the plurality of planter devices. In some aspects, the connection mechanisms 630 may be configured to store the plurality of planter devices, wherein the plurality of planter devices may be stacked. In some implementations, the connection mechanism 630 may be included on the outside of the plurality of planter devices, wherein the connection mechanism 630 may be configured to connect planter devices adjacent to one another. In some implementations, the plurality of planter devices may be stacked vertically and horizontally, as non-limiting examples.

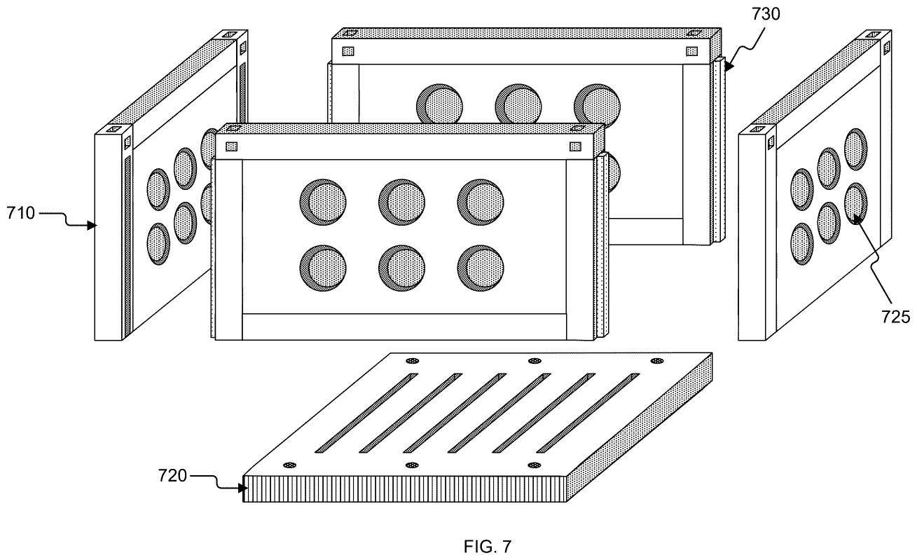

Referring now to FIG. 7, an exploded view of a planter device, according to some embodiments of the present disclosure, is illustrated. In some embodiments, the planter device may include four sides 710, a bottom portion 720, and one or more structural apertures 725. In some aspects, the four sides 710 may connect with one another and the bottom portion to form a rigid structure with a receiving cavity configured to contain planting material. In some embodiments, the four sides 710 may include at least one attachment mechanism 730 configured to attach one of the four sides 710 to at least two adjacent sides and the bottom portion 720. By way of example and not limitation, each of the four sides 710 may be attached to two adjacent sides and the bottom portion 720, wherein the planter device may be configured as a box-like shape with a receiving cavity to contain the planting material.

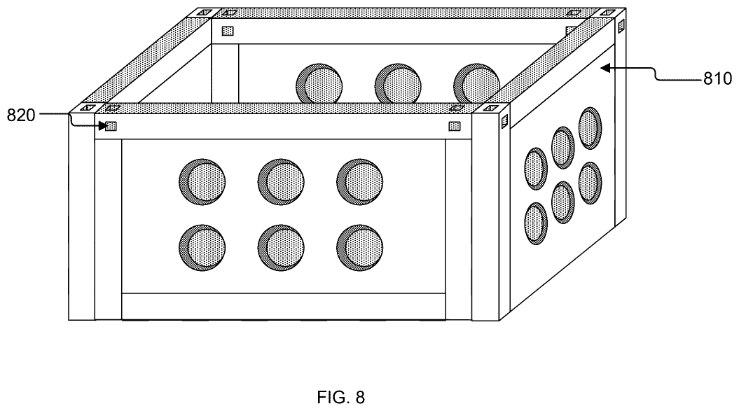

Referring now to FIG. 8, a perspective view of a planter device, according to some embodiments of the present disclosure, is illustrated. In some embodiments, the planter device may include four sides 810 and a bottom portion. In some implementations, the four sides 810 and the bottom portion may be configured to connect via one or more securing mechanisms 820. In some aspects, the one or more securing mechanisms 820 may include screws, pins, clips, or brackets. By way of example and not limitation, the four sides 810 and the bottom portion may include a marked location, a hole, or a threaded interior configured to receive the one or more securing mechanisms 820. In some aspects, the one or more securing mechanisms 820 may be added or removed to the planter device to assemble or disassemble the planter device, wherein the one or more securing mechanisms 820 may be configured to hold the four sides 810 and the bottom portion together.

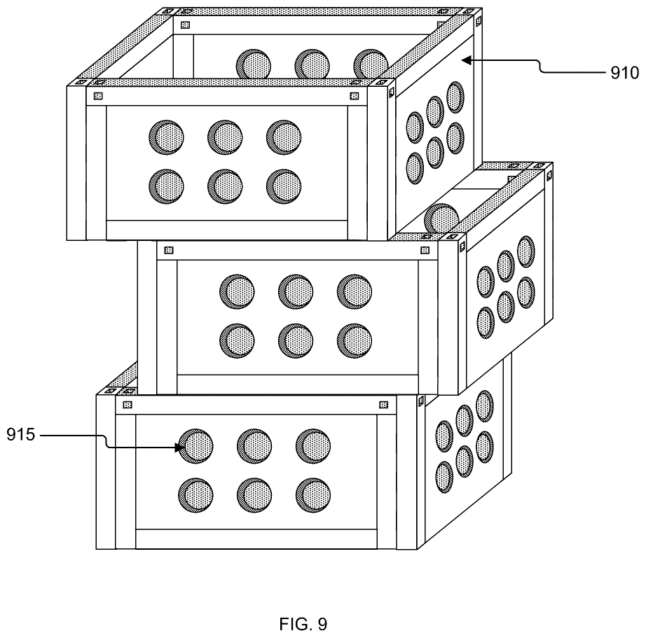

Referring now to FIG. 9, a plurality of planter devices, according to some embodiments of the present disclosure, is illustrated. In some embodiments, the plurality of planter devices may be stacked onto one another, wherein one of the plurality of planter devices may be placed on top of another one of the plurality of planter devices. In some aspects, the plurality of planter devices may include one or more structural apertures 915. In some implementations, the one or more structural apertures 915 may be included on the four sides 910. In some implementations, the bottom portion may include one or more slots.

By way of example and not limitation, the one or more structural apertures 915 and the one or more slots may be configured to increase the aeration and water mobility within the plurality of planter devices. In some aspects, planting material may be included in the plurality of planter devices, wherein watering the planter device at the top of the stack of the plurality of planter devices may also result in the watering of the other planter devices of the plurality of planter devices. In some implementations, the one or more structural apertures 915 and the one or more slots may be configured to maintain the structural integrity of the plurality of planter devices, wherein the presence of too much planting material may be addressed by the one or more structural apertures 915 and the one or more slots as the planting material may be released outside the one or more structural apertures 915 and the one or more slots.

### Conclusion

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

Reference in this specification to “one embodiment,” “an embodiment,” any other phrase mentioning the word “embodiment”, “aspect”, or “implementation” means that a particular feature, structure, or characteristic described in connection with the embodiment is included in at least one embodiment of the disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional.

Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

1. A planter device including:
four sides, wherein each of the four sides include at least one upper edge that defines the opening of a receiving cavity and at least one lower edge configured to interact with a bottom portion, wherein each of the four sides further includes:
one or more structural apertures centrally positioned on each of the four sides that provide openings into the receiving cavity;
at least one attachment mechanism positioned on the edges of each of the four sides except the at least one upper edge, wherein the at least one attachment mechanism is configured to attach each of the four sides and the bottom portion of the planter device;
the bottom portion perpendicular to each of the four sides, wherein the bottom portion is detachably connected to each of the four sides and each of the four sides and the bottom portion substantially form a rigid cuboidal structure that surrounds the receiving cavity configured to receive a planting material, wherein the bottom portion further includes:
one or more slots centrally positioned on the bottom portion that provide openings into the receiving cavity;
at least one attachment mechanism positioned on the edges of the bottom portion, wherein the at least one attachment mechanism is configured to connect to the at least one attachment mechanism of each of the four sides; and
at least one securing mechanism configured to secure each of the four sides and the bottom portion of the planter device together.

2. The planter device of claim 1, wherein the at least one securing mechanism is one or more screws, a snap and lock mechanism, pins, brackets, clips, or glue.

3. The planter device of claim 1, wherein the bottom portion includes one or more feet configured to elevate the planter device.

4. The planter device of claim 1, wherein the at least one attachment mechanism includes at least one interlocking mechanism.

5. The planter device of claim 4, wherein the at least one interlocking mechanism includes a protruding element and a recess element, wherein the protruding element of one of the four sides is received by the recess elements of another of the four sides.

6. The planter device of claim 1, wherein the one or more structural apertures includes holes or slits distributed along the four sides and the bottom portion of the planter device.

7. The planter device of claim 6, wherein the one or more structural apertures of the bottom portion includes slits and the one or more structural apertures of the four sides includes holes.

8. The planter device of claim 1, wherein the one or more structural apertures includes a stylistic design.

9. The planter device of claim 1, wherein the planting material is an orchard.

10. The planter device of claim 1, wherein the one or more structural apertures is reinforced with ridges or borders.

11. The planter device of claim 1, wherein the one or more feet creates a gap between the planter device and a surface.

12. The planter device of claim 1, wherein the one or more feet includes rubber pads or a textured surface.

13. A planter system including:
a plurality of planter devices, wherein each of the plurality of planter devices include:
four sides;
a bottom portion perpendicular to the four sides, wherein the four sides and the bottom portion form the physical structure that creates a receiving cavity configured to receive a planting material, wherein the four sides and the bottom portion further includes:
one or more structural apertures located on the four sides and the bottom portion;
at least one attachment mechanism, wherein the at least one attachment mechanism is configured to attach the four sides and the bottom portion of the planter device;
at least one securing mechanism configured to secure the four sides and the bottom portion of the planter device together; and
a connection mechanism configured to connect one of the plurality of planter devices to another one of the plurality of planter devices, wherein the plurality of planter devices are configured to stack.

14. The planter system of claim 13, wherein the bottom of the plurality of planter devices includes one or more feet configured to elevate the planter device and provide stability.

15. The planter system of claim 13, wherein the at least one attachment mechanism includes at least one interlocking mechanism, wherein a protruding element of one of the four sides is received by a recess element of another of the four sides.

16. The planter system of claim 13, wherein the connection mechanism includes a sliding lock, wherein the plurality of planter devices connects with one another.

17. The planter system of claim 14, wherein the one or more feet creates a gap between the planter device and a surface.

18. The planter system of claim 13, wherein the one or more structural apertures is reinforced with ridges or borders.

19. The planter system of claim 13, wherein the one or more structural apertures includes holes or slits distributed along the four sides and the bottom portion of the plurality of planter devices.

20. The planter system of claim 19, wherein the one or more structural apertures of the bottom portion include slits and the one or more structural apertures of the four sides includes holes.
